(19) United States
(12) Patent Application Publication
(10) Pub. No.: US 2024/0223028 A1
(43) Pub. Date: Jul. 4, 2024

(54) STATOR LAMINATION, INDUCTION MOTOR, COMPRESSOR AND REFRIGERATION DEVICE

(71) Applicant: Danfoss (Tianjin) Ltd., Tianjin (CN)

(72) Inventors: Guangqiang LIU, Nordborg (DK); Li YAO, Nordborg (DK); Yan LIN, Nordborg (DK); Wanzhen LIU, Nordborg (DK); Zhenyu WANG, Nordborg (DK); Meng WANG, Nordborg (DK)

(21) Appl. No.: 18/397,124

(22) Filed: Dec. 27, 2023

(30) Foreign Application Priority Data
Dec. 30, 2022 (CN) 202211721190.7
Dec. 30, 2022 (CN) 202223605034.2

(51) Int. Cl. H02K 1/16; F04C 18/02; F25B 31/02

(52) U.S. Cl. CPC H02K 1/165; F04C 18/0215; F25B 31/026; F04C 2240/40; H02K 2213/03

(57) ABSTRACT

A stator lamination, an induction motor, a compressor and a refrigeration device wherein the stator lamination is annular, and an inner circumference of the stator lamination is provided with a plurality of stator teeth and a plurality of stator slots. The plurality of stator teeth and the plurality of stator slots are arranged alternately. The stator lamination defines a stator inner diameter D₁, the number of the plurality of stator slots is Q₁, each stator slot defines a stator slot depth H₁, and the stator slot depth H₁ meets a formula:

$${H}_{1} = \frac{π {D}_{1}}{{Q}_{1}} * k .$$

Q₁ is greater than or equal to 24, the value range of D₁ is 95 mm to 105 mm, and the value range of k is 1.95 to 2.05.

### CROSS-REFERENCE TO RELATED APPLICATIONS

This application claims foreign priority benefits under 35 U.S.C. § 119 from Chinese Patent Applications No. 202211721190.7, filed Dec. 30, 2022, and No. 202223605034.2, filed Dec. 30, 2022, the content of each of which is hereby incorporated by reference in its entirety.

### TECHNICAL FIELD

The present disclosure relates to a field of motor technology, and in particular, to a stator lamination of an induction motor, an induction motor having the stator lamination, a compressor having the induction motor, and a refrigeration device having the compressor.

### BACKGROUND

An induction motor is a device for generating induction current in a rotor of the induction motor to achieve energy conversion through electromagnetic induction effect between a stator of the induction motor and the rotor. the induction motor is widely applied to various devices including a compressor of a refrigeration device due to its merits, such as, simple structure, low cost, high efficiency, high reliability, easier miniaturization, etc.

### SUMMARY

In view of the above, the present disclosure provides a stator lamination of an induction motor, an induction motor having the stator lamination, a compressor having the induction motor and a refrigeration device having the compressor.

In an aspect, the present disclosure provides a stator lamination of an induction motor. The stator lamination is annular. An inner circumference of the stator lamination is provided with a plurality of stator teeth and a plurality of stator slots. The plurality of stator teeth and the plurality of stator slots are arranged alternately. The stator lamination defines a stator inner diameter D₁. The number of the plurality of stator slots is Q₁. Each stator slot defines a stator slot depth H₁. The stator slot depth H₁ meets a formula:

$${H}_{1} = \frac{π {D}_{1}}{{Q}_{1}} * k .$$

Q₁ is greater than or equal to 24, the value range of D₁ may be from 95 mm to 105 mm, and the value range of k may be from 1.95 to 2.05. According to this configuration, the material cost of the induction motor can be reduced while the induction motor may achieve a target efficiency.

In a possible implementation, the stator inner diameter D₁ is substantially equal to 100.1 mm.

In a possible implementation, the stator lamination is made of silicon steel.

In a possible implementation, each stator tooth defines a stator tooth width T₁, and a ratio of the stator slot depth H₁ to the stator tooth width T₁, which is H₁/T₁, ranges from 3.8 to 4.0. According to this configuration, the material cost of the induction motor can be further reduced on the basis of ensuring that the induction motor achieves the target efficiency.

In another aspect, the present disclosure further provides an induction motor. The induction motor includes: an output shaft; a rotor, drivably connected to the output shaft, including a rotor core, the rotor core comprising a plurality of rotor laminations stacked arranged along an axial direction; and a stator, arranged on an outer circumference side of the rotor, comprising a stator core and a stator winding wound on the stator core, the stator core comprising a plurality of stator laminations, each one of which is the stator lamination described in the above aspect, stacked along an axial direction.

In a possible implementation, an outer circumference of each rotor lamination is provided with a plurality of rotor teeth and a plurality of rotor slots, the plurality of rotor teeth and the plurality of rotor slots are arranged alternately. Each rotor slot defines a rotor slot depth H₂, each rotor tooth defines a rotor tooth width T₂, and a ratio of the rotor slot depth H₂ to the rotor tooth width T₂, which is H₂/T₂, ranges from 5.7 to 6.1. According to this configuration, the material cost of the induction motor can be further reduced while the induction motor can achieve a target efficiency.

In a possible implementation, the plurality of rotor laminations are made of silicon steel.

In another aspect, the present disclosure further provides a compressor. The compressor includes: a shell, defining a low-pressure chamber and a high-pressure chamber therein, and provided with a suction inlet and a discharge outlet respectively communicated with the low-pressure chamber and the high-pressure chamber; a compressing mechanism, disposed in the low-pressure chamber, and including an orbiting scroll and a fixed scroll that cooperate with each other; and the induction motor as described in the above aspect, disposed in the low-pressure chamber. The output shaft of the induction motor is movably connected to the orbiting scroll to drive the orbiting scroll to move relative to the fixed scroll, so that the compression mechanism compresses the fluid in the low-pressure chamber and discharges the compressed fluid into the high-pressure chamber.

In a possible implementation, the stator winding forms a first winding assembly and a second winding assembly respectively at two ends of the stator core in an axial direction of the stator core. A distance between a centerline of the suction inlet and a midline of the first winding assembly in the axial direction is less than or equal to 10 mm, or a distance between the centerline of the suction inlet and a midline of the second winding assembly in the axial direction is less than or equal to 10 mm. According to this implementation, the stator winding will be cooled relatively efficiently by utilizing the fluid entering from the suction inlet. Therefore, this implementation is beneficial to heat dissipation of the induction motor.

In another aspect, the present disclosure further provides a refrigeration device which includes the compressor provided in the above aspect.

### BRIEF DESCRIPTION OF THE DRAWINGS

In order to illustrate technical solutions in embodiments of the present disclosure more clearly, the accompanying drawings to be used in the embodiments will be briefly described below.

It should be understood that the following drawings illustrate only certain embodiments of the present disclosure and are therefore not to be regarded as limiting the scope.

It should be understood that the same or similar reference numerals are used in the drawings to represent the same or similar elements (components or portions).

It should be understood that the drawings are only schematic, and the dimensions and proportions of elements (components or portions) in the figures are not necessarily precise.

FIG. 1 is a schematic structural diagram of an induction motor according to an embodiment of the present disclosure.

FIG. 2 is a schematic structural diagram showing a stator core and a rotor core of the induction motor in FIG. 1.

FIG. 3 is a schematic structural view showing a portion of a stator lamination of the stator core of FIG. 2.

FIG. 4 is a schematic structural view showing a portion of a rotor lamination of the rotor core of FIG. 2.

FIG. 5 is a schematic diagram illustrating a relationship between a ratio of material cost and efficiency of an induction motor and value k according to an example of the present disclosure.

FIG. 6 is a schematic cross-sectional view of a compressor according to an embodiment of the present disclosure.

### DETAILED DESCRIPTION

The technical solutions in the embodiments of the present disclosure will be clearly and completely described below in conjunction with the drawings in the embodiments of the present disclosure. The described embodiments are a part of embodiments of the present disclosure rather than all of the embodiments.

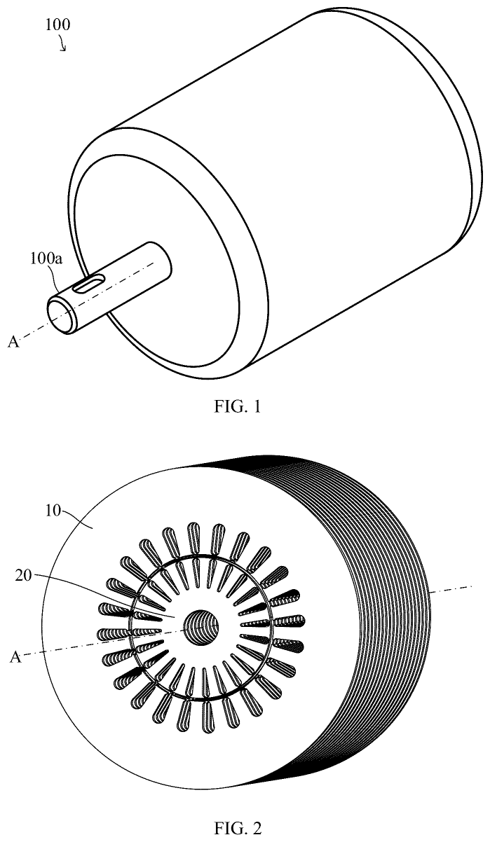

FIG. 1 is a schematic structural diagram of an induction motor 100 according to an embodiment of the present disclosure. In an example, the induction motor 100 may be applied in a compressor of a refrigeration device. Alternatively, the induction motor 100 may also be applied in other devices. This is not particularly limited in the present disclosure.

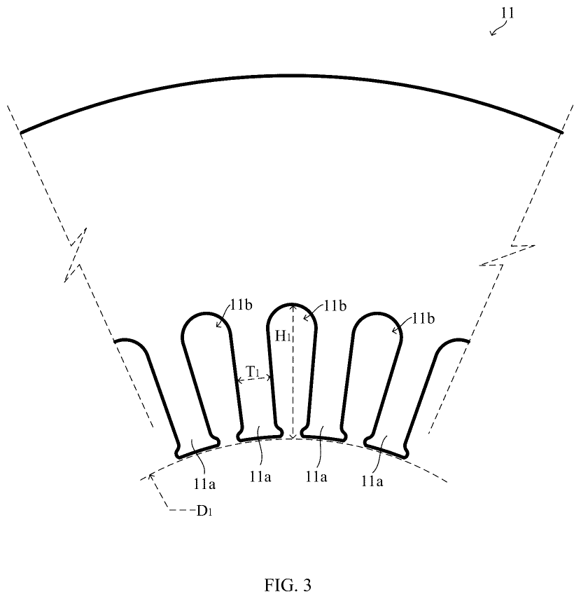

The induction motor 100 includes a stator and a rotor. The stator is arranged on the outer circumference side of the rotor. The output shaft 100a of the induction motor 100 is drivably connected to the rotor so as to rotate along with the rotor. The stator includes a stator core 10 and a stator winding (not shown) wound on the stator core 10. The rotor includes a rotor core 20. In certain embodiments, the rotor may also include a rotor winding (not shown) wound on the rotor core 20. FIG. 2 is a schematic structural diagram illustrating the stator core 10 and the rotor core 20. Referring to FIG. 2, the stator core 10 surrounds the rotor core 20.

When the induction motor 100 is in operation, a rotating magnetic field is generated through the current of the stator winding. The rotating magnetic field interacts with an induced current in the rotor to generate an electromagnetic torque. The electromagnetic torque causes the rotor to rotate and thereby drives the output shaft 100a to rotate, thereby converting the electric energy into the torque output by the output shaft 100a.

The stator core 10 includes a plurality of annular stator laminations 11 stacked along the axial direction of the induction motor 100. In the present disclosure, the axial direction of the induction motor 100 may refer to the extension direction of the axis A of the output shaft 100a. The material of the stator laminations 11 are not particularly limited in the present disclosure. For example, the stator laminations 11 may be made of silicon steel. In addition, the number of the stator laminations 11 is not particularly limited in the present disclosure.

FIG. 3 is a schematic structural diagram illustrating a portion of a stator lamination 11. Referring to FIG. 3, the inner circumference of the stator lamination 11 is provided with a plurality of stator teeth 11a and a plurality of stator slots 11b arranged in the circumferential direction. The plurality of stator slots 11b are respectively located between any two adjacent stator teeth 11a. That is, between any two adjacent stator teeth 11a is provided with one stator slot 11b. In other words, the plurality of stator teeth 11a and the plurality of stator slots 11b are alternately arranged.

The annular stator lamination has a stator inner diameter D₁, the value of the stator inner diameter D₁ ranges from 95 mm to 105 mm. In an embodiment, the stator inner diameter D₁ is substantially equal to 100.1 mm. The number of the plurality of stator slots is Q₁, Q₁ may be greater than or equal to 24. Each stator slot has a stator slot depth H₁, and the stator slot depth H₁ may meet a formula:

$${H}_{1} = \frac{π {D}_{1}}{{Q}_{1}} * k .$$

In this formula, the value of k may range from 1.95 to 2.05. According to this configuration, the material cost of the induction motor 100 may be reduced while the induction motor 100 may achieve target efficiency. In addition, the slot height Hₛ of the stator need not be too large, otherwise, under the same stator outer diameter and the stator inner diameter, the stator yoke thickness may become smaller, the stator rigidity may be affected, and vibration and noise may be affected.

It should be understood that, for example, the stator slot depth H₁ may be a size of the stator slot 11b in the radial direction.

Referring again to FIG. 3, each stator tooth 11a has a stator tooth width T₁. The ratio of the stator slot depth H₁ to the stator tooth width T₁ is H₁/T₁ which ranges from 3.8 to 4.0. According to this configuration, the material cost of the induction motor 100 can be further reduced while the induction motor 100 may reach the target efficiency.

It should be understood that the meaning of the stator tooth width is known to those having ordinary skill in the art. Exemplarily, the stator tooth width T₁ may refer to a distance between two opposite side surfaces of the stator tooth 11a in the circumferential direction at the middle of the stator tooth 11a.

Referring again to FIG. 2, the rotor core 20 includes a plurality of rotor laminations 21 arranged in a stacked manner along the axial direction of the induction motor 100. The material of the rotor laminations 21 are not particularly limited in the present disclosure. For example, the rotor laminations 21 may be made of silicon steel. In addition, the number of the rotor laminations 21 is not particularly limited in the present disclosure.

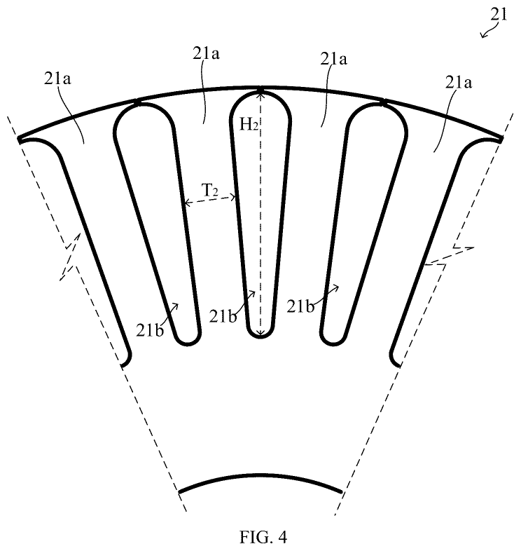

FIG. 4 is a schematic structural diagram illustrating a portion of a rotor lamination 21. Referring to FIG. 4, the outer circumference of the rotor lamination 21 is provided with a plurality of rotor teeth 21a and a plurality of rotor slots 21b arranged along the circumferential direction. The plurality of rotor slots 21b are respectively located between any two adjacent rotor teeth 21a. That is, between any two adjacent rotor teeth 21a is disposed one rotor slot 21b. In other words, the plurality of rotor teeth 21a and the plurality of rotor slots 21b are alternately arranged. The number of rotor teeth 21a and the number of rotor slots 21b are not particularly limited in the present disclosure.

Each rotor tooth 21a has a rotor tooth width T₂, and each rotor slot 21b has a rotor slot depth H₂. The ratio of the rotor slot depth H₂ to the rotor tooth width T₂ may range from 5.7 to 6.1. According to this configuration, the material cost of the induction motor 100 may be further reduced while the induction motor 100 may reach a target efficiency.

It should be understood that the meanings of the rotor tooth width and the rotor slot depth are known to those person having ordinary skill in the art. Exemplarily, the rotor tooth width T₂ may refer to the distance between two opposite side surfaces of the rotor tooth 21a in the circumferential direction at the middle of the rotor tooth 21a, and the rotor slot depth H₂ may refer to the size of the rotor slot 21b in the radial direction.

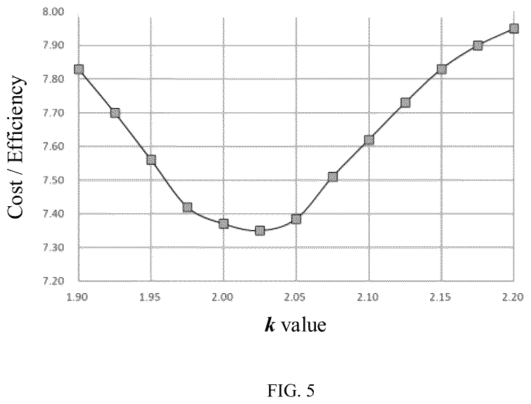

FIG. 5 is a schematic diagram illustrating a relationship between a ratio of material cost and efficiency of an induction motor and k value according to an example of the present disclosure. In this example, the stator lamination and the rotor lamination are both made of silicon steel, the stator inner diameter D₁ is 100.1 mm, the stator slot number Q₁ is greater than or equal to 24, the value range of the ratio H₁/T₁ is 3.8 to 4.0, the value range of H₂/T₂ is 5.7 to 6.1, and the stator slot depth H₁ meets the formula:

$${H}_{1} = \frac{π {D}_{1}}{{Q}_{1}} * k .$$

It may be learned from FIG. 5, when the value of k may fall within the range of 1.95 to 2.05, the ratio of material cost to efficiency of the induction motor is relatively low. That is, when the value range of k is 1.95 to 2.05, the material cost of the induction motor is relatively low, and the efficiency is relatively high. It can be seen that the value range of k may be set from 1.95 to 2.05, which is beneficial to reducing the material cost of the induction motor while the induction motor may reach a target efficiency.

Other embodiments of the present disclosure further provide a compressor, which includes the induction motor provided by the present disclosure. The compressor provided by the present disclosure may be applied to a refrigeration device. Certainly, the compressor provided by the present disclosure may also be applied to other devices, and this is not particularly limited in the present disclosure. The compressor provided by an embodiment of the present disclosure is described below by way of example with reference to the accompanying drawings.

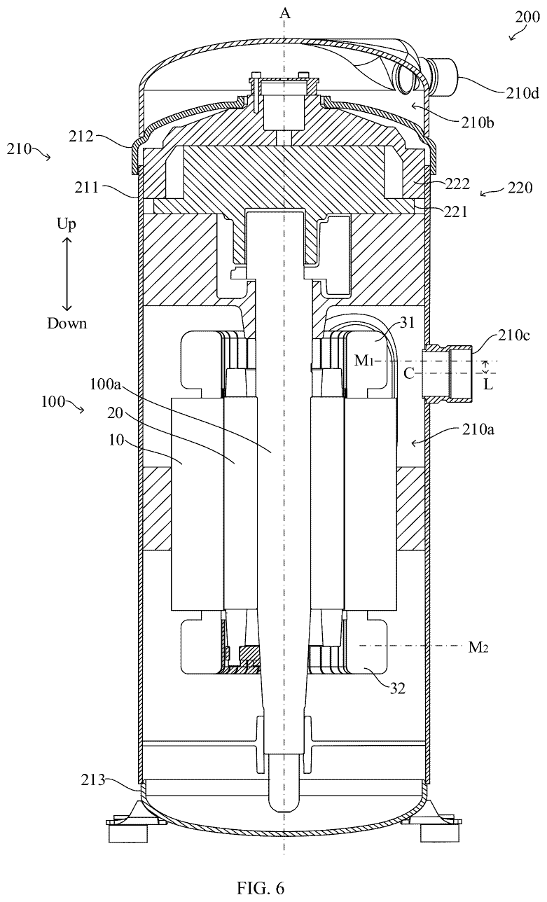

FIG. 6 is a schematic structural diagram of a compressor 200 according to an embodiment of the present disclosure. The compressor 200 may include the induction motor 100 provided by the foregoing embodiments of the present disclosure, and the compressor 200 may be a scroll compressor.

Referring to FIG. 6, the compressor 200 includes a shell 210, a low-pressure chamber 210a and a high-pressure chamber 210b are provided in the shell 210, the shell 210 is provided with a suction inlet 210c and a discharge outlet 210d, the suction inlet 210c is in communication with the low-pressure chamber 210a, and the discharge outlet 210d is in communication with the high-pressure chamber 210b. When the compressor 200 is running, the fluid enters the low-pressure chamber 210a from the suction inlet 210c, and then it is compressed and discharged into the high-pressure chamber 210b, and is finally discharged through the discharge outlet 210d. In one example, the shell 210 includes a middle shell 211, an upper cover 212 covering an upper end of the middle shell 211, and a lower cover 213 covering a lower end of the middle shell 211, the three together enclose a low-pressure chamber 210a, and the high-pressure chamber 210b is disposed in an interlayer of the upper cover 212.

In an embodiment, the compressor 200 further includes a compression mechanism 220, and the compression mechanism includes an orbiting scroll 221 and a fixed scroll 222, which cooperate with each other to achieve fluid compression. The induction motor 100 is located in the low-pressure chamber 210a, and the output shaft 100a of the induction motor 100 is movably connected to the orbiting scroll 221 to drive the orbiting scroll 221 to move relative to the fixed scroll 222, so that the compression mechanism 220 compresses the fluid in the low-pressure chamber 210a and discharges the compressed fluid into the high-pressure chamber 210b. In one example, the output shaft 100a of the induction motor 100 may be an eccentric crankshaft.

In an embodiment, the induction motor 100 may include a stator winding wound on the stator core 10. A first winding assembly 31 and a second winding assembly 32 are respectively formed at two ends of the stator core 10 in the axial direction of the stator core 10, and the first winding assembly 31 may also be referred to as an upper winding assembly, and the second winding assembly 32 may also be referred to as a lower winding assembly.

The suction inlet 210c may be close to the first winding assembly 31, specifically, the suction inlet 210c may define/have a center line C, and the first winding assembly 31 may define/have a center line M₁, wherein in the axial direction, the distance L between the center line C of the suction inlet 210c and the center line M₁ of the first winding assembly 31 may be less than or equal to 10 mm. In this way, the fluid entering from the suction inlet 210c can be relatively efficiently utilized to cool the stator winding 30 (i.e., mainly the first winding assembly 31 of the stator winding 30). Therefore, this implementation is beneficial to heat dissipation of the induction motor 100.

It should be noted that the midline M₁ may be an imaginary line that is located substantially in the middle of the first winding assembly 31 in the axial direction. In other words, in the axial direction, the distance from the upper end of the first winding assembly 31 to the center line M₁ is substantially equal to the distance from the lower end of the first winding assembly 31 to the center line M₁. It should be understood that, although the center line M₁ in FIG. 6 is located on the upper side of the center line C, in other examples, the center line M₁ may also be located on the lower side of the center line C.

As an alternative implementation, the suction inlet 210c may also be close to the second winding assembly 32, and the second winding assembly 32 may define a center line M₂, wherein in the axial direction, the distance between the center line C of the suction inlet 210c and the center line M₂ of the second winding assembly 32 may be less than or equal to 10 mm. In this way, the fluid entering from the suction inlet 210c can be relatively efficiently utilized to cool the stator winding 30 (i.e., mainly the second winding assembly 32 in this example). Therefore, this implementation is beneficial to heat dissipation of the induction motor 100.

It should be noted that the center line M₂ of the second winding assembly 32 may be an imaginary line that is located substantially in the middle of the second winding assembly 32 in the axial direction. In other words, in the axial direction, the distances from the center line M₂ to the upper end and the lower end of the second winding assembly 32 may be substantially equal.

Other embodiments of the present disclosure further provide a refrigeration device, which may include the compressor provided by the present disclosure. The refrigeration device provided by the present disclosure may be, for example, but not limited to, an air conditioner or a refrigerator.

It should be understood that the term “comprising” and its variations in the present disclosure are open, that is, they are mean “including but not limited to”. The term “one embodiment” means “at least one embodiment”, and the term” another embodiment “means” at least one further embodiment”.

It should be noted that the specific technical features (elements) described in the specific embodiments can be combined in any suitable mode without contradiction, and in order to avoid unnecessary repetition, the present disclosure no longer indicates various possible combination mode.

It should be understood that multiple members and/or portions can be provided by a single integrated member or portion. Alternatively, a single integrated member or portion may be divided into separate plurality of members and/or portions. “a” or “an” is used to describe the members or portions and is not said to exclude other components or portions.

The above is only a specific embodiment of the present disclosure, but the scope of protection of the present disclosure is not limited thereto, and any person having ordinary skill in the art could conceive of changing or replacing within the technical scope disclosed in the present disclosure, and should be covered within the protection scope of the present disclosure. Therefore, the protection scope of the invention shall be subject to the protection scope of the claims.

What is claimed is:

1. A stator lamination of an induction motor, wherein the stator lamination is annular, a plurality of stator teeth and a plurality of stator slots are configured at an inner circumference of the stator lamination, the plurality of stator teeth and the plurality of stator slots are arranged alternately, the stator lamination has a stator inner diameter D₁, the number of the plurality of stator slots is Q₁, each stator slot has a stator slot depth H₁, and the stator slot depth H₁ meets a formula:
$${H}_{1} = \frac{π {D}_{1}}{{Q}_{1}} * k ,$$
wherein Q₁ is greater than or equal to 24, a value of D₁ ranges from 95 mm to 105 mm, and a value of k ranges from 1.95 to 2.05.

2. The stator lamination as claimed in claim 1, wherein the stator inner diameter D₁ is substantially equal to 100.1 mm.

3. The stator lamination as claimed in claim 1, wherein the stator lamination is made of silicon steel.

4. The stator lamination as claimed in claim 1, wherein each stator tooth has a stator tooth width T₁, and a ratio of the stator slot depth H₁ to the stator tooth width T₁, which is H₁/T₁, ranges from 3.8 to 4.0.

5. An induction motor, comprising:
an output shaft;
a rotor, drivably connected to the output shaft, comprising a rotor core, and the rotor core comprising a plurality of rotor laminations stacked along an axial direction; and
a stator, arranged at an outer circumference side of the rotor, comprising a stator core and a stator winding wound on the stator core, the stator core comprising a plurality of stator laminations stacked along an axial direction, wherein each of the plurality of stator laminations is the stator lamination as claimed in claim 1.

6. The stator lamination as claimed in claim 5, wherein the stator inner diameter D₁ is substantially equal to 100.1 mm.

7. The stator lamination as claimed in claim 5, wherein each stator tooth has a stator tooth width T₁, and a ratio of the stator slot depth H₁ to the stator tooth width T₁, which is H₁/T₁, ranges from 3.8 to 4.0.

8. The induction motor as claimed in claim 5, wherein a plurality of rotor teeth and a plurality of rotor slots are arranged at an outer circumference of each rotor lamination, the plurality of rotor teeth and the plurality of rotor slots are arranged alternately, each of the rotor slots is configured with a rotor slot depth H₂, each rotor tooth has a rotor tooth width T₂, and a ratio of the rotor slot depth H₂ to the rotor tooth width T₂, which is H₂/T₂, ranges from 5.7 to 6.1.

9. The induction motor as claimed in claim 6, wherein a plurality of rotor teeth and a plurality of rotor slots are arranged at an outer circumference of each rotor lamination, the plurality of rotor teeth and the plurality of rotor slots are arranged alternately, each of the rotor slots is configured with a rotor slot depth H₂, each rotor tooth has a rotor tooth width T₂, and a ratio of the rotor slot depth H₂ to the rotor tooth width T₂, which is H₂/T₂, ranges from 5.7 to 6.1.

10. The induction motor as claimed in claim 7, wherein a plurality of rotor teeth and a plurality of rotor slots are arranged at an outer circumference of each rotor lamination, the plurality of rotor teeth and the plurality of rotor slots are arranged alternately, each of the rotor slots is configured with a rotor slot depth H₂, each rotor tooth has a rotor tooth width T₂, and a ratio of the rotor slot depth H₂ to the rotor tooth width T₂, which is H₂/T₂, ranges from 5.7 to 6.1.

11. The induction motor as claimed in claim 6, wherein the plurality of the rotor laminations are made of silicon steel.

12. A compressor, comprising:
a shell, defining a low-pressure chamber and a high-pressure chamber within the shell, and provided with a suction inlet and a discharge outlet which are respectively communicated with the low-pressure chamber and the high-pressure chamber;
a compressing mechanism, arranged in the low-pressure chamber, comprising an orbiting scroll and a fixed scroll that cooperate with each other; and
the induction motor as claimed in claim 5, arranged in the low-pressure chamber, wherein the output shaft of the induction motor is connected to the orbiting scroll to drive the orbiting scroll to move relative to the fixed scroll, wherein the compression mechanism compresses the fluid in the low-pressure chamber and discharges the compressed fluid into the high-pressure chamber.

13. The compressor as claimed in claim 12, wherein the stator winding forms a first winding assembly and a second winding assembly respectively at two ends of the stator core in an axial direction of the stator core, wherein a distance between a centerline of the suction inlet and a midline of the first winding assembly in the axial direction is less than or equal to 10 mm, or a distance between the centerline of the suction inlet and a midline of the second winding assembly in the axial direction is less than or equal to 10 mm.

14. The compressor as claimed in claim 13, wherein the stator inner diameter D₁ is substantially equal to 100.1 mm.

15. The compressor as claimed in claim 13, wherein each stator tooth has a stator tooth width T₁, and a ratio of the stator slot depth H₁ to the stator tooth width T₁, which is H₁/T₁, ranges from 3.8 to 4.0.

16. The compressor as claimed in claim 14, wherein a plurality of rotor teeth and a plurality of rotor slots are arranged at an outer circumference of each rotor lamination, the plurality of rotor teeth and the plurality of rotor slots are arranged alternately, each of the rotor slots is configured with a rotor slot depth H₂, each rotor tooth has a rotor tooth width T₂, and a ratio of the rotor slot depth H₂ to the rotor tooth width T₂, which is H₂/T₂, ranges from 5.7 to 6.1.

17. The compressor as claimed in claim 15, wherein a plurality of rotor teeth and a plurality of rotor slots are arranged at an outer circumference of each rotor lamination, the plurality of rotor teeth and the plurality of rotor slots are arranged alternately, each of the rotor slots is configured with a rotor slot depth H₂, each rotor tooth has a rotor tooth width T₂, and a ratio of the rotor slot depth H₂ to the rotor tooth width T₂, which is H/T₂, ranges from 5.7 to 6.1.

18. The compressor as claimed in claim 13, wherein the plurality of the rotor laminations are made of silicon steel.

19. A refrigeration device, wherein the refrigeration device comprises the compressor as claimed in claim 12.
